(19) United States
(12) Patent Application Publication
(10) Pub. No.: US 2017/0364799 A1
(43) Pub. Date: Dec. 21, 2017

(54) SIMPLIFYING APPARATUS AND SIMPLIFYING METHOD FOR NEURAL NETWORK

(71) Applicant: Kneron Inc., San Diego, CA (US)

(72) Inventors: Chun-Chen Liu, San Diego, CA (US); Kangli Hao, San Diego, CA (US); Liu Liu, San Diego, CA (US)

(21) Appl. No.: 15/182,616

(22) Filed: Jun. 15, 2016

(51) Int. Cl. G06N 3/08; G06N 3/04

(52) U.S. Cl. CPC G06N 3/082; G06N 3/04

(57) ABSTRACT

An apparatus for deciding a simplification policy for a neural network is provided. The deciding apparatus has a plurality of artificial neurons, a receiving circuit, a memory, and a simplifying module. The plurality of artificial neurons are configured to form an original neural network. The receiving circuit receives a set of sample for training the original neural network. The memory is used for recording a plurality of learnable parameters for the original neural network. After the original neural network has been trained with the set of sample, the simplifying module abandons a part of neuron connections in the original neural network based on the learnable parameters recorded by the memory. The simplifying module accordingly decides the structure of a simplified neural network and a plurality of learnable parameters for the simplified neural network.

### BACKGROUND OF THE INVENTION

### 1. Field of the Invention

The present invention relates to artificial neural networks. In particular, the present invention relates to techniques for simplifying artificial neural networks.

### 2. Description of the Prior Art

The idea of artificial neural networks has existed for a long time. Nevertheless, limited computation ability of hardware had been an obstacle to related researches. Over the last decade, there are significant progresses in computation capabilities of processors and algorithms of machine learning. Not until recently did an artificial neural network that can generate reliable judgments become possible. Gradually, artificial neural networks are experimented in many fields such as autonomous vehicles, image recognition, natural language understanding, and data mining.

Neurons are the basic computation units in a brain. Each neuron receives input signals from its dendrites and produces output signals along its single axon (usually provided to other neurons as input signals). The typical operation of an artificial neuron can be modeled as:

$$y = f ( {\sum }_{i} {w}_{i} {x}_{i} + b ) , \qquad ( Eq . 1 )$$

wherein x represents the input signal, y represents the output signal. Each dendrite multiplies a weight w to its input signal x; this parameter is used to simulate the strength of influence of one neuron on another. The symbol b represents a bias contributed by the artificial neuron itself. The symbol f represents a specific nonlinear function and is generally implemented as a sigmoid function, hyperbolic tangent (tanh) function, or rectified linear function in practical computation.

For an artificial neural network, the relationship between its input data and final judgment is in effect defined by the weights and biases of all the artificial neurons in the network. In an artificial neural network adopting supervised learning, training samples are fed to the network. Then, the weights and biases of artificial neurons are adjusted with the goal to find out a judgment policy that make final judgments match training samples. In an artificial neural network adopting unsupervised learning, whether a final judgment matches the training sample is unknown. The network adjusts the weights and biases of artificial neurons and tries to find out an underlying rule. No matter which kind of learning is adopted, the goals are the same—finding out suitable parameters (i.e. weights and biases) for each neuron in the network. The determined parameters will be utilized in future computation.

Currently, most artificial neural networks are designed as having a multi-layer structure. Layers serially connected between the input layer and the output layer are called hidden layers. The input layer receives external data and does not perform computation. In a hidden layer or the output layer, input signals are the output signals generated by its previous layer, and each artificial neuron included therein respectively performs computation according to Equation 1. Each hidden layer and output layer can respectively be a convolutional layer or a fully-connected layer. The main difference between a convolutional layer and a fully-connected layer is that neurons in a fully connected layer have full connections to all neurons in its previous layer. On the contrary, neurons in a convolutional layer are connected only to a local region of its previous layer. Besides, many artificial neurons in a convolutional layer share learnable parameters.

At the present time, there are a variety of network structures. Each structure has its unique combination of convolutional layers and fully-connected layers. Taking the AlexNet structure proposed by Alex Krizhevsky et al. in 2012 as an example, the network includes 650,000 artificial neurons that form five convolutional layers and three fully-connected layers connected in serial.

Generally speaking, the learning ability of a neural network is proportional to its total number of computational layers. A neural network with few computational layers has restricted learning ability. In face of complicated training samples, even if a large number of trainings are performed, a neural network with few computational layers usually cannot find out a judgment policy that makes final judgments match training samples (i.e. cannot converge to a reliable judgment policy). Therefore, when a complicated judgment policy is required, a general practice is implementing an artificial neural network with numerous (e.g. twenty-nine) computational layers by utilizing a super computer that has abundant computation resources.

On the contrary, the hardware size and power in a consumer electronic product (especially a mobile device) are strictly limited. The hardware in most mobile phones can only implement an artificial neural network with at most five computational layers. At the present time, when an application related to artificial intelligence is executed on a consumer electronic product, the consumer electronic product is usually connected to the server of a service provider via the Internet and requests the super computer at the remote end to assist in computing and sending back a final judgment. However, such practice has a few drawbacks. First, the stability of an Internet connection is sensitive to the environment. Once the connection is unstable, the remote super computer may not provide its final judgment to the consumer electronic product immediately. However, for applications related to personal safety such as autonomous vehicles, immediate responses are urgently necessary and relying on a remote super computer is risky. Second, the Internet transmission is usually charged based on data volume. Undoubtedly, this would be a burden on many consumers.

### SUMMARY OF THE INVENTION

To solve the aforementioned problem, simplifying apparatuses and simplifying methods for a neural network are provided.

One embodiment according to the invention is a simplifying apparatus for a neural network. The simplifying apparatus includes a plurality of artificial neurons, a receiving circuit, a memory, and a simplifying module. The plurality of artificial neurons are configured to form an original neural network. The receiving circuit is coupled to the plurality of artificial neurons and receives a set of sample for training the original neural network. The memory records a plurality of learnable parameters of the original neural network. After the original neural network has been trained with the set of sample, the simplifying module abandons a part of neuron connections in the original neural network based on the plurality of learnable parameters recorded in the memory. The simplifying module accordingly decides the structure of a simplified neural network.

Another embodiment according to the invention is a method for simplifying a neural network. First, an original neural network formed by a plurality of neurons is trained with a set of sample, so as to decide a plurality of learnable parameters of the original neural network. Then, based on the decided learnable parameters, a part of neuron connections in the original neural network is abandoned, so as to decide the structure of a simplified neural network.

Another embodiment according to the invention is a non-transitory computer-readable storage medium encoded with a computer program for simplifying a neural network. The computer program includes instructions that when executed by one or more computers cause the one or more computers to perform operations including: (a) training an original neural network formed by a plurality of neurons with a set of sample, so as to decide a plurality of learnable parameters of the original neural network; and (b) based on the plurality of learnable parameters decided in operation (a), abandoning a part of neuron connections in the original neural network, so as to decide the structure of a simplified neural network.

The advantage and spirit of the invention may be understood by the following recitations together with the appended drawings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a three-layer artificial neural network as an example of the original neural network according to the invention.

FIG. 2(A) to FIG. 2(C) are a set of examples for showing the difference between neural networks before and after abandoning a part of neuron connections.

FIG. 3(A) to FIG. 3(C) are another set of examples for showing the difference between neural networks before and after abandoning a part of neuron connections.

FIG. 4 shows the curve of the hyperbolic tangent function.

FIG. 5 shows an embodiment that the simplifying apparatus according to the invention further includes an input analyzer.

FIG. 6 illustrates the flowchart of a simplifying method in one embodiment according to the invention.

The figures described herein include schematic block diagrams illustrating various interoperating functional modules. It should be noted that such diagrams are not intended to serve as electrical schematics and interconnections illustrated are intended to depict signal flow, various interoperations between functional components and/or processes and are not necessarily direct electrical connections between such components. Moreover, the functionality illustrated and described via separate components need not be distributed as shown, and the discrete blocks in the diagrams are not necessarily intended to depict discrete electrical components.

### DETAILED DESCRIPTION

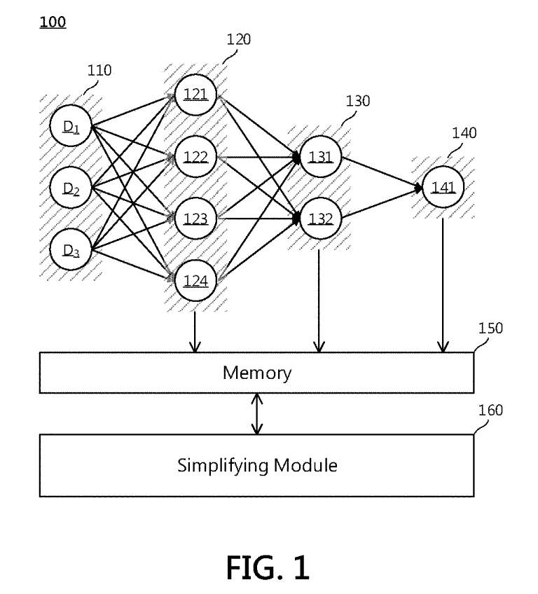

One embodiment according to the invention is a simplifying apparatus for a neural network. The simplifying apparatus includes a plurality of artificial neurons, a receiving circuit, a memory, and a simplifying module. The plurality of artificial neurons are configured to form an original neural network. FIG. 1 shows a three-layer artificial neural network as an example of the original neural network. It should be noted that although actual artificial neural networks include much more artificial neurons and have much more complicated interconnections than this example, those ordinarily skilled in the art can understand, through the following introduction, the scope of the invention is not limited to a specific network complexity.

Please refer to FIG. 1. The receiving circuit (i.e. input layer) 110 is used for receiving external data D₁ to D₃. There are two hidden layers between the receiving circuit 110 and the output layer 140. The hidden layers 120 and 130 are fully-connected layers. The hidden layer 120 includes four artificial neurons (121 to 124) and the hidden layer 130 includes two artificial neurons (131 to 132). The output layer 140 includes only one artificial neuron (141). The memory 150 is coupled to the artificial neurons in each computational layer. The simplifying module 160 is coupled to the memory 150.

First, a set of sample for training the original neural network 100 is sent into the receiving circuit 110. The scope of the invention is not limited to the format of sample or number of samples in the set. For example, the set of sample can be images, audio data, or text documents. Each artificial neuron performs computation based on its input signals and respective learnable parameters (weights and biases). In the process of machine learning, no matter the learning strategy includes only forward propagation or both forward propagation and backpropagation, these learnable parameters might be continuously adjusted. It is noted that how the learnable parameters are adjusted in a machine learning process are known by those ordinarily skilled in the art and not further described hereinafter. The scope of the invention is not limited to details in the learning process.

During and after the learning process, the memory 150 is responsible for storing the latest learnable parameters for artificial neurons in the hidden layers 120, 130 and output layer 140. For example, the computation result O₁₂₁ of the artificial neuron 121 is:

O₁₂₁=f(D₁w₁₂₁_{_{D1}}+D₂w₁₂₁_{_{D2}}+D₃w₁₂₁_{_{D3}}+b₁₂₁). (Eq. 2)

Correspondingly, aiming to the artificial neuron 121, the learnable parameters recorded by the memory 150 include a bias b and three weights w₁₂₁_{_{D1}}, w₁₂₁_{_{D2}}, and w₁₂₁_{_{D3}} respectively related to external data D₁ to D₃. The rest may be inferred. It is noted that each weight w recorded in the memory 150 is corresponding to a specific neuron connection in the original neural network 100. According to the records in the memory 150, the starting point and the end point of a neuron connection can also be known.

The scope of the invention is not limited to specific storage mechanisms. Practically, the memory 150 can include one or more volatile or non-volatile memory device, such as a dynamic random access memory (DRAM), a magnetic memory, an optical memory, a flash memory, etc. Physically, the memory 150 can be a single device or be separated into a plurality of smaller storage units disposed adjacent to the artificial neurons in the original neural network 100, respectively.

The simplifying module 160 can be implemented by a variety of processing platforms. Fixed and/or programmable logic, such as field-programmable logic, application-specific integrated circuits, microcontrollers, microprocessors and digital signal processors, may be included in the simplifying module 160. Embodiments of the simplifying module 160 may also be fabricated to execute a process stored in the memory 150 as executable processor instructions. After the original neural network 100 has been trained with the set of sample, based on the learnable parameters recorded in the memory 150, the simplifying module 160 abandons a part of neuron connections in the original neural network 100 and accordingly decides the structure of a simplified neural network. In the following paragraphs, several simplification policies can be adopted by the simplifying module 160 are introduced.

In one embodiment, the simplifying module 160 includes a comparator circuit. After retrieving the weights w corresponding to apart or all of the neuron connections in the original neural network 100, the simplifying module 160 utilizes the comparator circuit to judge whether the absolute value |w| of each retrieved weight w is lower than a threshold T. If an absolute value |w| is lower than the threshold T, the simplifying module 160 abandons the neuron connection corresponding to this weight w. The simplifying module 160 can record its decisions (i.e. whether a neuron connection is abandoned or kept) in the memory 150. For example, for each neuron connection, the circuit designer can set a storage unit in the memory 150 for storing a flag. The default status of the flag is a first status (e.g. binary 1). After determining to abandon a neuron connection, the simplifying module 160 changes the flag of this neuron connection from the first status to a second status (e.g. binary 0).

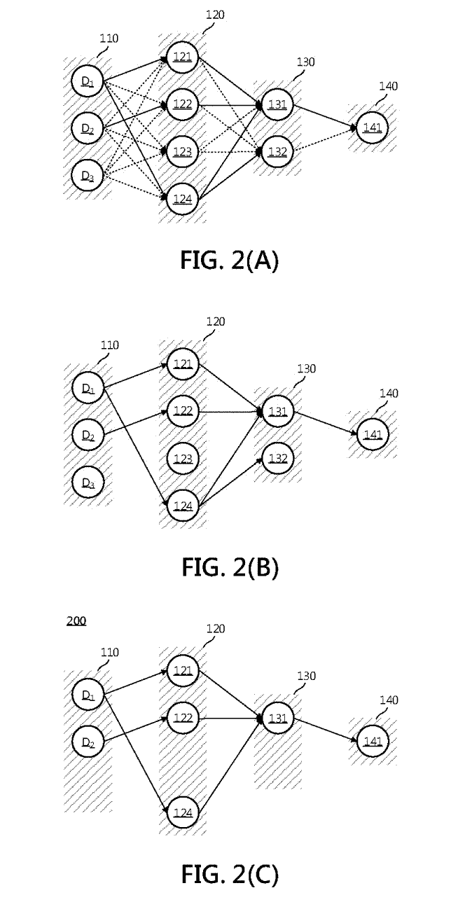

In practice, the threshold T adopted by the simplifying module 160 can be an absolute number (e.g. 0.05) generated based on experience or mathematical derivation. Alternatively, the threshold T can be a relative value, such as one-twentieth of the average absolute value of all the weights win the original neural network 100. FIG. 2(A) to FIG. 2(C) are a set of examples for showing the difference between neural networks before and after abandoning a part of neuron connections according to this simplification policy. In FIG. 2(A), the neuron connections drawn as dashed lines are corresponding to weights with absolute values lower than the threshold T and referred to as weaker neuron connections. FIG. 2(B) illustrates the result after the simplifying module 160 abandons all these weaker neuron connections. After abandoning the weaker neuron connections, neither the node for receiving the external data D₃ nor the artificial neuron 123 has any neuron connection with other artificial neurons. The external data D₃ becomes non-effective data, and the artificial neuron 123 becomes a non-effective artificial neuron. Hence, as shown in FIG. 2(C), the external data D₃ and the artificial neuron 123 can also be abandoned.

As described above, a weight w is used to simulate the strength of influence of one neuron on another. The lower an absolute value |w|, the smaller the influence. Abandoning weaker neuron connections is equivalent to abandoning computation terms having smaller influence on final judgments generated by the original neural network 100 (i.e. the computation result O₁₄₁ of the artificial neuron 141). It is noted that, in FIG. 2(B), although the artificial neuron 132 still has a neuron connection with its preceding artificial neuron 124, but there is no neuron connection between the artificial neuron 132 and any rear artificial neuron. Under this condition, the computation result O₁₃₂ of the artificial neuron 132 has a negligible influence on the artificial neuron 141. Hence, in FIG. 2(C), the artificial neuron 132 is also abandoned.

By comparing FIG. 2(A) and FIG. 2(C), it is seen the computation amount in the simplified neural network 200 is much lower than that in the original neural network 100. The effect of simplification is obviously achieved.

Circuit designers can determine the threshold T according to practical requirements. With a higher threshold T, the simplifying module 160 would abandon more neuron connections and introduce a larger difference between the final judgments (O₁₄₁) before and after simplification. On the contrary, with a lower threshold T, the difference between the original neural network 100 and the simplified neural network 200 would be smaller, and their final judgments would be closer to each other. By appropriately selecting the threshold T, circuit designers can limit the difference between final judgments in a tolerable range, and achieve, at the same time, the effect of reducing computation amount in the neural network. Practically, the tolerable range can be different for every application that utilizes the simplified neural network. Therefore, the tolerable range is not limited to a specific value.

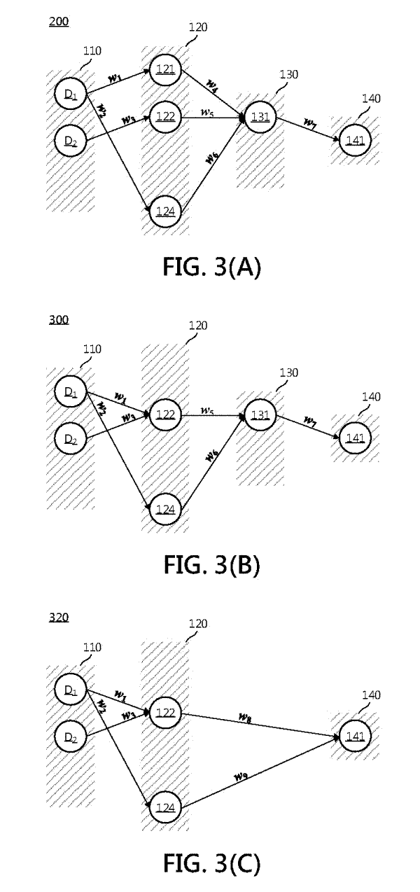

In another embodiment, based on the learnable parameters, the simplifying module 160 judges whether the operation executed by a first neuron can be merged into the operation executed by a second neuron. Once the first neuron is merged, one or more neuron connections connected to the first neuron is abandoned accordingly. The simplified neural network 200 in FIG. 2(C) is re-drawn in FIG. 3(A) as an example. First, based on the records in the memory 150, the simplifying module 160 tries to find out at least two weights conforming to both the following requirements: (1) corresponding to the same rear artificial neuron, and (2) having values close to each other (e.g. their difference falls in a predetermined small range). Taking FIG. 3(A) as an example, the weights w₄, w₅, and w₆ are corresponding to the same rear artificial neuron 131. By utilizing a comparator circuit, the simplifying module 160 can judge whether at least two weights among the weights w₄, w₅, and w₆ are conforming to the aforementioned requirement (2).

Assume the output of the comparator circuit indicates the two weights w₄ and w₅ are close to each other. Then, also by using a comparator circuit, the simplifying module 160 further judges whether all the weights utilized in the computation of the preceding artificial neurons corresponding to the weights w₄ and w₅ are lower than a threshold T′. In FIG. 3(A), the preceding artificial neurons corresponding to the weights w₄ and w₅ are the artificial neurons 121 and 122, respectively. The weight utilized in the computation of the artificial neuron 121 is the weight w₁. The weight utilized in the computation of the artificial neuron 122 is the weight w₃. If the two absolute values |w₁| and |w₃| are both lower than the threshold T′, the simplifying module 160 can merge the operation executed by the artificial neuron 121 into the operation executed by the artificial neuron 122. The reason and detail of this merging are described below.

If a hyperbolic tangent (tanh) function is taken as the computational function f of the artificial neuron 131, its computation result O₁₃₁ is:

O₁₃₁=tanh(O₁₂₁w₄+O₁₂₂w₅+O₁₂₄w₆+b₁₃₁). (Eq. 3)

Since the weights w₄ and w₅ are close to each other, the two terms O₁₂₁w₄ and O₁₂₂w5 in Equation 3 can be merged and approximated by linear superposition as:

$${O}_{121} {w}_{4} + {O}_{122} {w}_{5} ≅ ( {O}_{121} + {O}_{122} ) {w}_{5} = [ tanh ( {D}_{1} {w}_{1} + {b}_{121} ) + tanh ( {D}_{2} {w}_{3} + {b}_{122} ) ] {w}_{5} ≅ tanh ( {D}_{1} {w}_{1} + {D}_{2} {w}_{2} + {b}_{121} + {b}_{122} ) {w}_{5} . \qquad ( Eq . 4 )$$

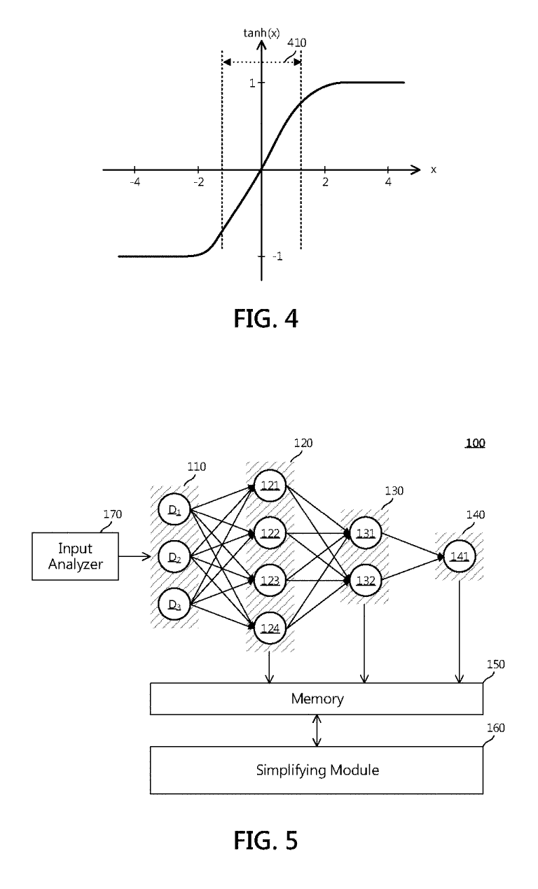

FIG. 4 shows the curve of a hyperbolic tangent function. In the range 410, tanh(x) is approximately a straight line and can be approximated as a linear function f(x)=ax, wherein the symbol a is the slope of this line section.

Although the external data D₁ and D₂ in Equation 4 is unknown, it has been known the two absolute values |w₁| and |w₃| are both lower than the threshold T′. Hence, it's very possible that the three values (D₁w₁+b₁₂₁), (D₂w₃+b₁₂₂), and (D₁w₁+D₂w₃+b₁₂₁+b₁₂₂) all fall in the range 410. If the three values do all fall in the range 410, the linear superposition performed in Equation 4 almost not changes the computation result. In other words, as long as the threshold T′ is properly chosen to ensure that |w₁| and |w₃| are low enough, the simplification in Equation 4 would be reasonable under most conditions. Practically, the threshold T′ is not limited to a specific value and can be selected by circuit designers based on experience or mathematical derivation.

It is noted that since the two absolute values |w₁| and |w₃| are both low (at least lower than the threshold T′), even if the three values (D₁w₁+b₁₂₁), (D₂w₃+b₁₂₂), and (D₁w₁+D₂w₃+b₁₂₁+b₁₂₂) do not all fall in the range 410, the error introduced by linear superposition in Equation 4 is usually small.

FIG. 3(B) shows a simplified neural network 300 corresponding to Equation 4 . As shown in FIG. 3(B), the neuron connection originally set between the external data D₁ and the artificial neuron 121 is moved to the artificial neuron 122. The neuron connection originally set between the artificial neurons 121 and 131 is abandoned. Under this condition, the weight w₄ is no longer needed, and the values of the other weights w remain unchanged. In the simplified neural network 300, the computation result O₁₃₁ of the artificial neuron 131 can be expressed as:

O₁₂₁+tanh(O′₁₂₂w₅+O₁₃₄w₆+b₁₃₁), (Eq. 5)

Wherein O′₁₂₂=tanh(D₁w₁+D₂w₃+b′₁₂₂). The original bias b₁₂₁ of the artificial neuron 121 is merged to the artificial neuron 122; a new bias b′₁₂₂ (=b₁₂₁+b₁₂₂) of the artificial neuron 122 is generated. The simplifying module 160 generates the new bias and then records these modifications of connection relationships and learnable parameters into the memory 150.

Similarly, if the three weights w₄, w₅, and w₆ are all close to each other, the simplifying module 160 may even merge the three artificial neurons 121, 122, and 124 into one artificial neuron. More generally, according to the learnable parameters recorded in the memory 150, the simplifying module 160 can determine merging which group of artificial neurons is better (e.g. can reduce more computation amount or minimize the difference between two final judgments).

Artificial neurons that can be merged by the simplifying module 160 are not limited to artificial neurons in the same computational layer. Based in the plurality of learnable parameters, the simplifying module 160 can determine whether to merge the operation executed by a first computational layer into the operation executed by a second computational layer. In one embodiment, the simplifying module 160 merges a computational layer conforming to the following requirement into another computational layer: all neuron connections taking this computational layer as the rear computational layer are corresponding to weights with absolute values lower than a threshold T″.

Taking FIG. 3(B) as an example, all neuron connections taking the hidden layer 130 as the rear computational layer are corresponding to weights w₅, and w₆. Therefore, the simplifying module 160 can utilize a comparator circuit to judge whether the absolute values |w₅| and |w₅| are both lower than the threshold T″. If the comparison result indicates the absolute values |w₅| and |w₆| are both lower than the threshold T″, the simplifying module 160 can merge the operation executed by the hidden layer 130 into the operation executed by the output layer 140. The reason and detail of this merging are described below.

If a hyperbolic tangent function is taken as the computational function f of the artificial neuron 141, its computation result O₁₄₁ is:

$$\begin{matrix}{O}_{141} = tanh ( {O}_{131} {w}_{7} + {b}_{141} ) \\ = tanh [ tanh ( {O}_{122} {w}_{5} + {O}_{124} {w}_{6} + {b}_{131} ) {w}_{7} + {b}_{141} ] .\end{matrix} \qquad ( Eq . 6 )$$

If the nonlinear function f(x)=tanh(x) used by the artificial neuron 131 is replaces by a linear function f(x)=ax, Equation 6 can be rewritten as:

$${O}_{141} ≅ tanh [ a ( {O}_{122} {w}_{5} + {O}_{124} {w}_{6} + {b}_{131} ) {w}_{7} + {b}_{141} ] = tanh [ {O}_{122} ( {aw}_{5} {w}_{7} ) + {O}_{124} ( {aw}_{6} {w}_{7} ) + ( {ab}_{131} {w}_{7} + {b}_{141} ) ] . \qquad ( Eq . 7 )$$

Although the computation results O₁₂₂ and O₁₂₄ are unknown for the artificial neuron 131, it has been known the two absolute values |w₅| and |w₆| are both lower than the threshold T″. Hence, it's very possible the value (O₁₂₂w₅+O₁₂₄w₆+b₁₃₁) falls in the range 410. If the value (O₁₂₂w₅+O₁₂₄w₆+b₁₃₁) does fall in the range 410, replacing the nonlinear function f(x)=tanh(x) by the linear function f(x)=ax almost not changes the computation result. In other words, the computation results of Equation 6 and Equation 7 would be almost the same. Therefore, as long as the threshold T″ is properly chosen to ensure that |w₅| and |w₆| are low enough, the simplification in Equation 7 would be reasonable under most conditions. Practically, the threshold T″ is not limited to a specific value and can be selected by circuit designers based on experience or mathematical derivation.

It is noted that since the two absolute values |w₅| and |w₆| are both low (at least lower than the threshold T″), even if the value (O₁₂₂w₅+O₁₂₄w₆+b₁₃₁) does not fall in the range 410, the error introduced by replacing the computation function is usually small.

FIG. 3(C) shows a simplified neural network 320 corresponding to Equation 7. In this example, the operation originally executed by the artificial neuron 131 is merged to the operation executed by the artificial neuron 141 in the output layer 140. The neuron connection originally set between the artificial neurons 131 and 141 is abandoned. The neuron connection originally set between the artificial neurons 122 and 131 is replaced by a new neuron connection set between the artificial neurons 122 and 141. This new neuron connection is corresponding to a new weight w₈ that equals the total weight aw₅w₇ related to the computation result O₁₂₂ in Equation 7. Similarly, the neuron connection originally set between the artificial neurons 124 and 131 is replaced by a new neuron connection set between the artificial neurons 124 and 141. This new neuron connection is corresponding to a new weight w₉ that equals the total weight aw₆w₇ related to the computation result O₁₂₄ in Equation 7. Moreover, the simplifying module 160 also changes the bias of the artificial neuron 141 from b₁₄₁ to the value (ab₁₃₁w₇+b₁₄₁) in Equation 7. The simplifying module 160 records these modified connection relationship and learnable parameters into the memory 150.

In this example, the hidden layer 130 is abandoned. The neuron connections connected to the hidden layer 130 are also abandoned accordingly. Compared with the original neural network 100, the simplified neural network 320 has not only lower computation amount but also fewer computational layers. It is seen that if the learnable parameters conform to the aforementioned requirement, it is possible for the simplifying module 160 to decrease the number of computational layers in a neural network.

It is noted that the simplifying module 160 can adopt only one aforementioned simplification policy. The simplifying module 160 can also adopt and perform a plurality of simplification policies in an original neural network. Additionally, the simplifying module 160 can perform the same one simplification policy for several times. For example, the simplifying module 160 can set another threshold and further simplify the simplified neural network 320 by abandoning neuron connections with absolute values lower than this threshold. The simplifying module 160 may also directly merge artificial neurons or computational layers without abandoning weaker neuron connections first.

The aforementioned simplification policies can be applied to not only a fully-connected layer but also a convolutional layer. Furthermore, besides the artificial neurons, the receiving circuit, the memory, and the simplifying module in FIG. 1, a simplifying apparatus according to the invention can include other circuits, such as but not limited to a pooling layer connected subsequent to a convolutional layer and an oscillator for generating clock signals. Those ordinarily skilled in the art can comprehend that the scope of the invention is not limited to a specific network structure. A simplifying apparatus according to the invention can be applied to but not limited to the following network structures: the LeNet proposed by Yann LeCun, the AlexNet proposed by Alex Krizhevsky et al., the ZF Net proposed by Matthew Zeiler et al., the GoogLeNet proposed by Szegedy et al., the VGGNet proposed by Karen Simonyan et al., and the ResNet proposed by Kaiming He et al.

In one embodiment, the original neural network 100 is a reconfigurable neural network. In other words, by adjusting routings between artificial neurons, the structure of the neural network can be reconfigured. After deciding the structure of a simplified neural network, the simplifying module 160 further reconfigures the artificial neurons in the original neural network 100 to form a simplified neural network based on the modified connection relationships and learnable parameters recorded in the memory 150. For example, assuming the simplifying module 160 determines to adopt the structure of the simplified neural network 320, the simplifying module 160 can select three artificial neurons (e.g. artificial neurons 121 to 123) from the seven artificial neurons in the original neural network 100. The simplifying module 160 can configure, by adjusting routings, the three artificial neurons and the receiving circuit 110 to form the connection relationship shown in FIG. 3(C). Compared with the original neural network 100 used in the training process, the simplified neural network 320 consumes less power and fewer memory accessing resources when being used for following judgments. Since the simplified neural network 320 has fewer computational layers, the computation time is also shorter.

In another embodiment, after deciding the structure of a simplified neural network, the simplifying module 160 provides the structure of the simplified neural network to another plurality of artificial neurons. For instance, the original neural network 100 can be a super computer having a lot of (e.g. twenty-nine) computational layers and high learning ability. First, with the cooperation with the original neural network 100, the simplifying module 160 decides the structure of a simplified neural network. Then, this simplified structure is applied to a neural network with only few computational layers implemented by the processor in a consumer electronic product. For example, manufacturers of consumer electronic products can design an artificial neural network chip that has a fixed hardware structure according to the simplified structure decided by the simplifying module 160. Alternatively, if a reconfigurable neural network is included in a consumer electronic product, the reconfigurable neural network can be configured according to the simplified structure decided by the simplifying module 160. Practically, the simplified structure decided by the simplifying module 160 can be compiled into a configuration file as a reference for consumer electronic products. The simplifying module 160 can even generate a variety of simplified structures based on a plurality of sets of training samples. Accordingly, a plurality of configuration files corresponding to different applications can be provided to a consumer electronic product. The consumer electronic product can first select one structure and then select another next time.

As described above, a neural network formed by few computational layers has restricted learning ability. In the face of complicated training samples, even if a large number of trainings are performed, a neural network formed by few computational layers usually cannot converge to a reliable judgment policy. Utilizing the concept of the invention, a super computer with high learning ability can be responsible for the training process and finds out a complete judgment policy. The neural network with few computational layers in a consumer electronic product does not have to learn by itself but only to utilize a simplified version of the complete judgment policy. Although the judgment result of a simplified neural network may not be exactly the same as that of an original neural network, the simplified judgment policy at least does not have the problem of unable to converge. If the simplifying module 160 adopts simplification policies properly, a simplified neural network can even generate final judgments very similar to that generated by an original neural network.

Please refer to FIG. 5. In this embodiment, the simplifying apparatus according to the invention further includes an input analyzer 170. The input analyzer 170 is used for receiving a set of original samples and performing a component analysis on the set of original samples. Practically, the component analysis can be but not limited to a principle component analysis or an independent component analysis. The input analyzer 170 extracts at least one basic component of the set of original samples. For instance, the set of original samples maybe ten thousand original data (e.g. ten thousand pictures of human faces), and the input analyzer 170 generates therefrom only fifty basic components (e.g. fifty characteristics common to human facial features).

The input analyzer 170 provides the at least one basic component to the receiving circuit 110 as the set of sample for training the original neural network 100. Compared with providing ten thousand original data to train the original neural network 100, training the original neural network 100 with only fifty basic components is much less time consuming. Because the basic components extracted by the input analyzer 170 usually can indicate the most distinctive features of the set of original samples, training the original neural network 100 with basic components can achieve a considerably nice training effect most of the time. It is noted that the details of a component analysis are known by those ordinarily skilled in the art and not further described hereinafter. The scope of the invention is not limited to details in the component analysis.

In one embodiment, after a simplified neural network is formed, the set of original samples analyzed by the input analyzer 170 is provided to train the simplified neural network. Training the simplified neural network with lots of original samples is practicable because the computation amount is less and the computation time is shorter in the simplified neural network. Moreover, at the beginning, the simplified neural network has already had a converged judgment policy. By training the simplified neural network with the set of original samples, the learnable parameters in the simplified neural network can be further optimized.

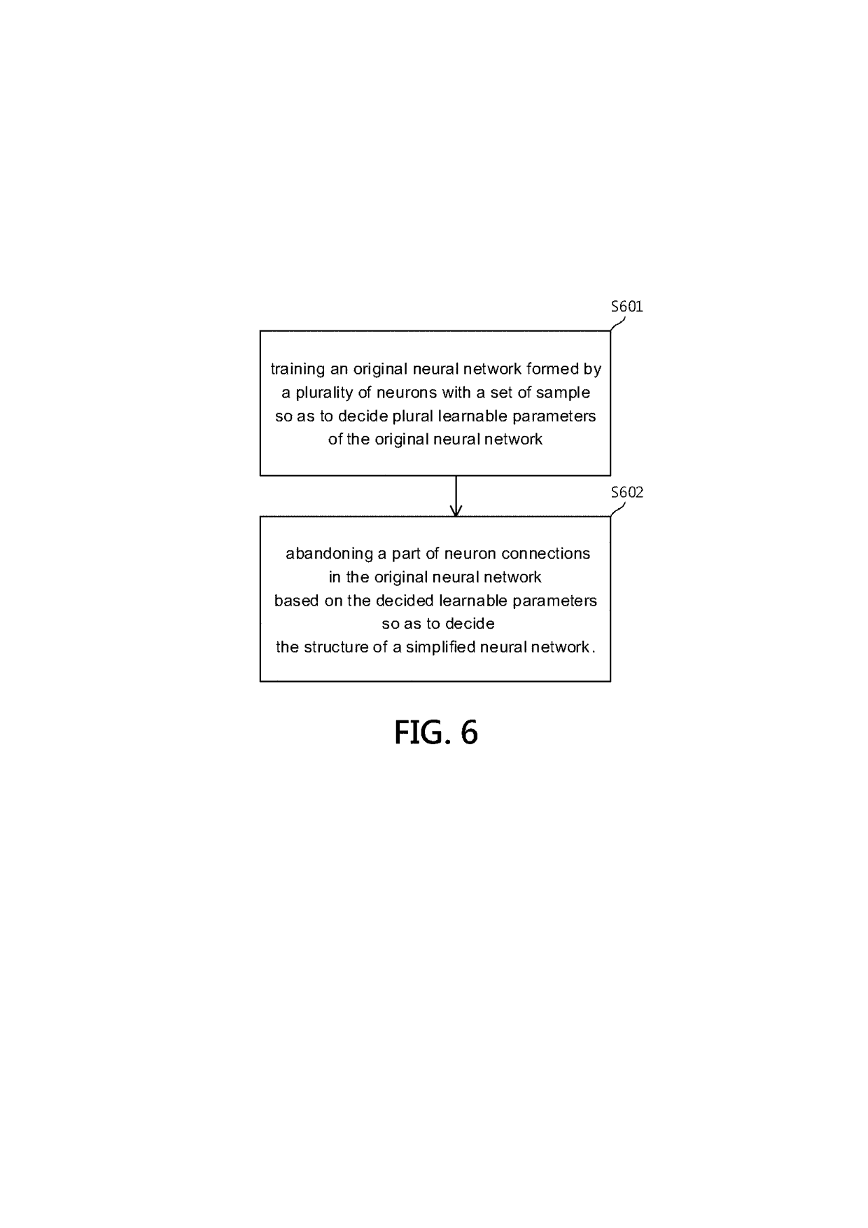

Another embodiment according to the invention is a simplifying method for a neural network. Please refer to the flowchart in FIG. 6. First, step S601 is training an original neural network formed by a plurality of neurons with a set of sample, so as to decide a plurality of learnable parameters of the original neural network. Subsequently, step S602 is abandoning a part of neuron connections in the original neural network based on the plurality of learnable parameters decided in step S601, so as to decide the structure of a simplified neural network.

Those ordinarily skilled in the art can comprehend that the variety of variations relative to the aforementioned simplifying apparatuses can also be applied to the simplifying method in FIG. 6 and the details are not described again.

Another embodiment according to the invention is a non-transitory computer-readable storage medium encoded with a computer program for simplifying a neural network. The computer program includes instructions that when executed by one or more computers cause the one or more computers to perform operations including: (a) training an original neural network formed by a plurality of neurons with a set of sample, so as to decide a plurality of learnable parameters of the original neural network; and (b) based on the plurality of learnable parameters decided in operation (a), abandoning a part of neuron connections in the original neural network, so as to decide the structure of a simplified neural network.

Practically, the aforementioned computer-readable storage medium may be any non-transitory medium on which the instructions maybe encoded and then subsequently retrieved, decoded and executed by a processor, including electrical, magnetic and optical storage devices. Examples of non-transitory computer-readable recording media include, but not limited to, read-only memory (ROM), random-access memory (RAM), and other electrical storage; CD-ROM, DVD, and other optical storage; and magnetic tape, floppy disks, hard disks and other magnetic storage. The processor instructions may be derived from algorithmic constructions in various programming languages that realize the present general inventive concept as exemplified by the embodiments described above. The variety of variations relative to the aforementioned simplifying apparatuses can also be applied to the non-transitory computer-readable storage medium and the details are not described again.

With the example and explanations above, the features and spirits of the invention will be hopefully well described. Those ordinarily skilled in the art will readily observe that numerous modifications and alterations of the device may be made while retaining the teaching of the invention. Accordingly, the above disclosure should be construed as limited only by the metes and bounds of the appended claims. Additionally, mathematical expressions are contained herein and those principles conveyed thereby are to be taken as being thoroughly described therewith. It is to be understood that where mathematics are used, such is for succinct description of the underlying principles being explained and, unless otherwise expressed, no other purpose is implied or should be inferred. It will be clear from this disclosure overall how the mathematics herein pertain to the present invention and, where embodiment of the principles underlying the mathematical expressions is intended, the ordinarily skilled artisan will recognize numerous techniques to carry out physical manifestations of the principles being mathematically expressed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A simplifying apparatus for a neural network, comprising:
a plurality of artificial neurons configured to form an original neural network;
a receiving circuit, coupled to the plurality of neurons, for receiving a set of sample for training the original neural network;
a memory, coupled to the plurality of neurons, for recording a plurality of learnable parameters of the original neural network; and
a simplifying module coupled to the memory, after the original neural network has been trained with the set of sample, the simplifying module abandoning a part of neuron connections in the original neural network based on the plurality of learnable parameters recorded in the memory, the simplifying module accordingly deciding the structure of a simplified neural network.

2. The simplifying apparatus of claim 1, wherein the plurality of learnable parameters comprises a weight parameter, the simplifying module judges whether the absolute value of the weight parameter is lower than a threshold; if the judging result is positive, the simplifying module abandons the neuron connection corresponding to this weight parameter.

3. The simplifying apparatus of claim 1, wherein the original neural network comprises a first artificial neuron and a second artificial neuron; based on the plurality of learnable parameters, the simplifying module determines whether to merge the operation executed by the first artificial neuron into the operation executed by the second artificial neuron.

4. The simplifying apparatus of claim 1, wherein the original neural network comprises a first computational layer and a second computational layer; based on the plurality of learnable parameters, the simplifying module determines whether to merge the operation executed by the first computational layer into the operation executed by the second computational layer.

5. The simplifying apparatus of claim 1, further comprising:
an input analyzer for receiving a set of original samples and performing a component analysis on the set of original samples, so as to extract at least one basic component of the set of original samples, the input analyzer providing the at least one basic component to the receiving circuit as the set of sample for training the original neural network.

6. The simplifying apparatus of claim 5, wherein the component analysis is a principle component analysis or an independent component analysis.

7. The simplifying apparatus of claim 5, wherein after the simplified neural network is formed, the set of original samples is used to train the simplified neural network, so as to modify the plurality of learnable parameters for the simplified neural network.

8. The simplifying apparatus of claim 1, wherein after deciding the structure of the simplified neural network, the simplifying module reconfigures the plurality of artificial neurons to form the simplified neural network.

9. The simplifying apparatus of claim 1, wherein the simplifying module provides the structure of the simplified neural network to another plurality of artificial neurons.

10. A method for simplifying a neural network, comprising:
(a) training an original neural network formed by a plurality of artificial neurons with a set of sample, so as to decide a plurality of learnable parameters of the original neural network; and
(b) based on the plurality of learnable parameters decided in step (a), abandoning a part of neuron connections in the original neural network, so as to decide the structure of a simplified neural network.

11. The method of claim 10, wherein the plurality of learnable parameters comprises a weight parameter, and step (b) comprises:
judging whether the absolute value of the weight parameter is lower than a threshold; and
if the judging result is positive, abandoning the neuron connection corresponding to this weight parameter.

12. The method of claim 10, wherein the original neural network comprises a first artificial neuron and a second artificial neuron, and step (b) comprises:
based on the plurality of learnable parameters, determining whether to merge the operation executed by the first artificial neuron into the operation executed by the second artificial neuron; and
abandoning one or more neuron connection of the first artificial neuron.

13. The method of claim 10, wherein the original neural network comprises a first computational layer and a second computational layer, and step (b) comprises:
based on the plurality of learnable parameters, determining whether to merge the operation executed by the first computational layer into the operation executed by the second computational layer; and
abandoning one or more neuron connection of the first computational layer.

14. The method of claim 10, further comprising:
receiving a set of original samples;
performing a component analysis on the set of original samples, so as to extract at least one basic component of the set of original samples; and
taking the at least one basic component as the set of sample for training the original neural network.

15. The method of claim 14, wherein the component analysis is a principle component analysis or an independent component analysis.

16. The method of claim 14, further comprising:
after the simplified neural network is formed, training the simplified neural network with the set of original samples and accordingly modifying a plurality of learnable parameters of the simplified neural network.

17. The method of claim 10, further comprising:
after step (b), reconfiguring the plurality of artificial neurons to form the simplified neural network.

18. The method of claim 10, further comprising:
after step (b), applying the structure of the simplified neural network to another plurality of artificial neurons.

19. A non-transitory computer-readable storage medium encoded with a computer program for simplifying a neural network, the computer program comprising instructions that when executed by one or more computers cause the one or more computers to perform operations comprising:
(a) training an original neural network formed by a plurality of artificial neurons with a set of sample, so as to decide a plurality of learnable parameters of the original neural network; and
(b) based on the plurality of learnable parameters decided in operation (a), abandoning a part of neuron connections in the original neural network, so as to decide the structure of a simplified neural network.

20. The non-transitory computer-readable storage medium of claim 19, wherein the plurality of learnable parameters comprises a weight parameter, and the abandoning operation comprises:
judging whether the absolute value of the weight parameter is lower than a threshold; and
if the judging result is positive, abandoning the neuron connection corresponding to this weight parameter.

21. The non-transitory computer-readable storage medium of claim 19, wherein the original neural network comprises a first artificial neuron and a second artificial neuron, and the abandoning operation comprises:
based on the plurality of learnable parameters, determining whether to merge the operation executed by the first artificial neuron into the operation executed by the second artificial neuron; and
abandoning one or more neuron connection of the first artificial neuron.

22. The non-transitory computer-readable storage medium of claim 19, wherein the original neural network comprises a first computational layer and a second computational layer, and the abandoning operation comprises:
based on the plurality of learnable parameters, determining whether to merge the operation executed by the first computational layer into the operation executed by the second computational layer; and
abandoning one or more neuron connection of the first computational layer.

23. The non-transitory computer-readable storage medium of claim 19, wherein when executed by the one or more computers, the instructions further cause the one or more computers to perform operations comprising:
receiving a set of original samples;
performing a component analysis on the set of original samples, so as to extract at least one basic component of the set of original samples; and
taking the at least one basic component as the set of sample for training the original neural network.

24. The non-transitory computer-readable storage medium of claim 23, wherein the component analysis is a principle component analysis or an independent component analysis.

25. The non-transitory computer-readable storage medium of claim 23, wherein when executed by the one or more computers, the instructions further cause the one or more computers to perform operations comprising:
after the simplified neural network is formed, training the simplified neural network with the set of original samples and accordingly modifying a plurality of learnable parameters of the simplified neural network.

26. The non-transitory computer-readable storage medium of claim 19, wherein when executed by the one or more computers, the instructions further cause the one or more computers to perform operations comprising:
after operation (b), reconfiguring the plurality of artificial neurons to form the simplified neural network.

27. The non-transitory computer-readable storage medium of claim 19, wherein when executed by the one or more computers, the instructions further cause the one or more computers to perform operations comprising:
providing the structure of the simplified neural network to another plurality of artificial neurons.
